(19) United States
(12) Patent Application Publication
(10) Pub. No.: US 2026/0009928 A1
(43) Pub. Date: Jan. 8, 2026

(54) NON-LOCAL RESONANCE-BASED METASURFACE FILTER AND METHOD OF MANUFACTURING METASURFACE

(71) Applicant: KOREA UNIVERSITY RESEARCH AND BUSINESS FOUNDATION, Seoul (KR)

(72) Inventors: Soo Jin KIM, Seoul (KR); Yu Geun KI, Seoul (KR)

(21) Appl. No.: 18/917,011

(22) Filed: Oct. 16, 2024

(30) Foreign Application Priority Data
Jul. 5, 2024 (KR) 10-2024-0089043

(51) Int. Cl. G02B 1/00; G02B 27/28

(52) U.S. Cl. CPC G02B 1/002; G02B 27/288

(57) ABSTRACT

Disclosed are a metasurface filter and a method of manufacturing a metasurface. A metasurface filter includes: a substrate; and a metasurface layer in which a plurality of unit structures formed on the substrate and having the same shape are arranged to form one structure group, and at least one of a specific polarization and a specific wavelength is blocked according to resonance according to an arrangement of the unit structures in one structure group, wherein the plurality of unit structures forming the one structure group may be placed to have different angles.

### CROSS-REFERENCE TO RELATED APPLICATION

This application claims under 35 U.S.C. § 119(a) the benefit of Korean Patent Application No. 10-2024-0089043 filed on Jul. 5, 2024, the entire contents of which are incorporated herein by reference.

### BACKGROUND

### (a) Technical Field

The present disclosure relates to a metasurface filter and a method of manufacturing a metasurface.

### (b) Background Art

Optical components that have been manufactured from existing glass-based materials have clear limitations to be applied to flexible and wearable devices. In recent years, attempts have been made to manufacture optical control components into thinner and smaller devices in line with the development direction of digital devices. As a result, a research for implementing a metasurface is actively conducted.

The metasurface is commonly referred to as a thin film which can control light as desired through a structure design of several nanometers smaller than a wavelength of the light. Through the structure design, a desired function can be implemented beyond a unique property of a material, and a research to implement a lens, a color filter, polarization manufacturing and detection is actively progressed through a metasurface having a thickness of several nanometers instead of a thick glass-based material.

In an initial stage of implementing the metasurface, a pattern is implemented with a metallic material to which a localized surface plasmon (LSP) principle is applied. A device is implemented which forms a pattern with gold (Au), silver (Ag), or aluminum (Al), and performs various functions through a phenomenon which occurs on the surface.

These metallic materials have a disadvantage in that due to a large heat loss (intrinsic loss) in wavelength bands often used, such as visible rays (400 to 700 nm) and near-infrared rays (700 to 2000 nm), a device having a high quality (Q)-factor cannot be implemented in the corresponding wavelength band.

The higher the Q-factor, the longer the energy of light can stay without loss, which means that a resolution in a frequency band can be higher. When the device having the high Q-factor is used, energy can be efficiently used, and multiple frequency bands can also be efficiently distributed, so light control and detection can be more precisely performed, which becomes a scale of performance in an optical field.

In this regard, a metallic material--based metasurface has a limitation. Further, the metallic material-based metasurface has a large limitation in that compatibility deteriorates in a CMOS process, and also has a disadvantage in that it is very difficult to mass production in a product step through a unit pattern process.

In order to overcome the disadvantage of the metallic material-based metasurface, a metasurface made of a dielectric material including silicon (Si), silicon nitride (Si₃N₄), dioxide titanium (TiO₂), etc., appears. The dielectric material has an advantage that the dielectric material has an easy process and low heat loss compared to the metallic material. However, since the dielectric material is transparent in a thin-film state compared to the metallic material, there is a large limitation (i.e., a limitation that a radiation loss is large) in that the energy does not stay long in the device and escapes.

### SUMMARY OF THE DISCLOSURE

The present disclosure is to provide a metasurface filter and a method of manufacturing a metasurface, which may detect a wavelength and polarization of light simultaneously.

In addition, the present disclosure is to provide a metasurface filter and a method of manufacturing the metasurface, which may detect linear polarization and circular polarization with one unit cell (nano structure), and easily make the linear polarization and the circular polarization filter on one plane through optimization in the same process because one unit cell (nano structure) is used.

In addition, the present disclosure is to provide a metasurface filter and a method of manufacturing the metasurface, which may detect the wavelength and the polarization of the light capable of detecting the polarization based on transmittance simultaneously.

In addition, the present disclosure is to provide a metasurface filter and a method of manufacturing the metasurface, which enable designing a dielectric-based metasurface having a high Q-factor by using non-local resonance, and may detect the wavelength and the polarization of the light which are easy to be applied to a smart device due to low energy loss and good frequency selectivity.

In addition, the present disclosure is to provide a metasurface filter and a method of manufacturing the metasurface, which may detect the wavelength and the polarization of the light simultaneously, which enable circular polarization detection with a single layer metasurface.

According to an aspect of the present disclosure, provided is a metasurface filter.

According to an embodiment of the present disclosure, a metasurface filter may be provided, which includes: a substrate; and a metasurface layer in which a plurality of unit structures formed on the substrate and having the same shape are arranged to form one structure group, and at least one of a specific polarization and a specific wavelength is blocked according to resonance according to an arrangement of the unit structures in one structure group, wherein the plurality of unit structures forming the one structure group are placed to have different angles.

The unit structure may be formed to have a predetermined height in an elliptical shape with a length ratio of a long axis and a short axis having 1.05 to 1.2:1.

In the one structure group, four unit structures may be arranged, and arranged to have an angle difference of 90 degrees from an adjacent unit structure, but in the one structure group, the plurality of unit structures may be arranged in a rectangular lattice shape.

The metasurface layer may be formed by a combination of a plurality of structure groups, and orientation angles of the unit structures in the plurality of structure groups may be different from each other, and the plurality of structure groups may be formed by at least one of a first group arranged in a rectangular lattice so that a long-axis based orientation angle of the unit structure has 0 degree and 90 degrees; a second group arranged in the rectangular lattice so that the long-axis based orientation angle of the unit structure has 45 degree and 135 degrees; a third group arranged in the rectangular lattice so that the long-axis based orientation angle of the unit structure has 22.5 degree and 112.5 degrees; and a fourth group arranged in the rectangular lattice so that the long-axis based orientation angle of the unit structure has −22.5 degree and 67.5 degrees, or by a combination of the first to third groups.

The unit structure may be made of a dielectric material.

According to another embodiment of the present disclosure, a method of manufacturing a metasurface may be provided, which may include: depositing a dielectric layer on a substrate; patterning a unit structure shape on the dielectric layer through electron-beam lithography; depositing a chrome hard mask through electron-beam deposition, and then performing a lift-off process to form a chrome pattern; and performing silicon etching by using the chrome pattern as a mask, and then eliminating the chrome pattern through wet etching, wherein an orientation angle of the unit structure may be determined differently according to at least one of a targeted polarization and a targeted wavelength.

An embodiment of the present disclosure provides a metasurface filter and a method of manufacturing the metasurface capable of simultaneously detecting linear polarization and circular polarization, thereby detecting polarization and circular polarization with one unit cell (nano structure), and easily making the linear polarization and the circular polarization on one plane through optimization in the same process because of using one unit cell (nano structure).

Further, according to the present disclosure, a wavelength and polarization of light can be simultaneously detected, which are capable of detecting polarization based on transmittance.

In addition, according to the present disclosure, designing a dielectric-based metasurface having a high Q-factor is enabled by using non-local resonance, and the wavelength and the polarization of the light which are easy to be applied to a smart device can be simultaneously detected due to low energy loss and good frequency selectivity.

Further, according to the present disclosure, the wavelength and the polarization of the light can be simultaneously detected, which are capable of detecting circular polarization detection with a single layer metasurface.

### BRIEF DESCRIPTION OF THE DRAWINGS

FIG. 1 is a diagram illustrating a metasurface filter according to an embodiment of the present disclosure.

FIG. 2 and FIG. 3 are diagrams illustrating an analysis result for a phase relationship between local and non-local modes induced on a metasurface layer according to an embodiment of the present disclosure.

FIGS. 4 to 8 are diagrams illustrated to describe optimization of the metasurface layer through vector analysis of a complex transmission coefficient based on adjustment of an orientation angle of a unit structure according to an embodiment of the present disclosure.

FIG. 9 and FIG. 10 are diagrams illustrating a transmission spectrum measurement result according to an embodiment of the present disclosure.

FIGS. 11 to 14 are diagrams illustrating a result of measuring various polarization states at a direction of an azimuthal angle and an elliptical angle by using a metasurface combination according to an embodiment of the present disclosure.

FIG. 15 to FIG. 19 are diagrams illustrating a polarization state recovered from the metasurface layer manufactured under various complex polarizations according to an embodiment of the present disclosure.

FIG. 20 is a flowchart illustrating a method for manufacturing a metasurface according to an embodiment of the present disclosure.

### DETAILED DESCRIPTION

A singular form used herein may include a plural form unless the context clearly indicates otherwise. In the present specification, a term such as “comprising” or “including” should not be interpreted as necessarily including all various components or various steps described in the specification, and it should be interpreted that some components or some steps among them may not be included or additional components or steps may be further included. In addition, the terms including “part', “module”, and the like described in the specification mean a unit that processes at least one function or operation, which may be implemented in hardware or software or as a combination of hardware and software.

Hereinafter, the embodiment of the present disclosure will be described in detail with reference to the accompanying drawings.

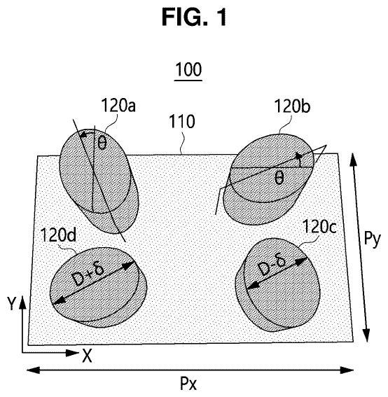

FIG. 1 is a diagram illustrating a metasurface filter according to an embodiment of the present disclosure.

Referring to FIG. 1, in the metasurface filter 100 according to an embodiment of the present disclosure, metasurface layers 120a to 120d are formed on a substrate 110.

The metasurface layers 120a to 120d are formed on the substrate, and each of a plurality of unit structures formed in the same shape is arranged to form one structure group, and at least one of specific polarization and a specific wavelength may be transmitted according to resonance in a placement direction of a unit structure arrangement in one structure group to transmit a desired targeted polarization and a desired targeted wavelength.

In an embodiment of the present disclosure, for convenience of understanding and description, by assuming that the arrangement of four unit structures forms one group (structure group), this will be primarily described.

Each unit structure is formed in an elliptical pillar shape, and an elliptical shape may be formed so that a length ratio of a long axis and a short axis has 1.05 to 1.2:1. For example, when a length of the long axis of each unit structure is 265 nm, the short axis may have a length of 215 nm.

Four unit structures in one structure group may be placed in an arrangement of a×b (i.e., a lattice arrangement). Here, a and b may be natural numbers less than n (a natural number of 4 or more).

In an embodiment of the present disclosure, it is assumed that one structure group is formed by the arrangement of four unit structures, and on the assumption that four unit structures are placed in an arrangement of 2×2, this will be primarily described.

In placing four unit structures to form one structure group, four unit structures are arranged in different placement direction, and at least one of the desired targeted polarization and the desired targeted wavelength may be transmitted and detected by filtering at least one of the specific polarization and the specific wavelength according to resonance characteristics depending on the placement. To this end, four unit structures forming one structure group may be arranged so that a difference of 90 degrees is generated between adjacent unit structures.

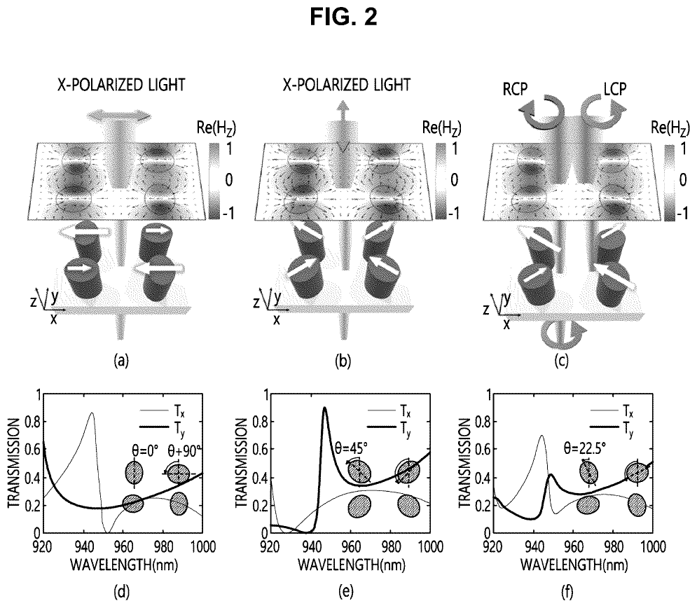

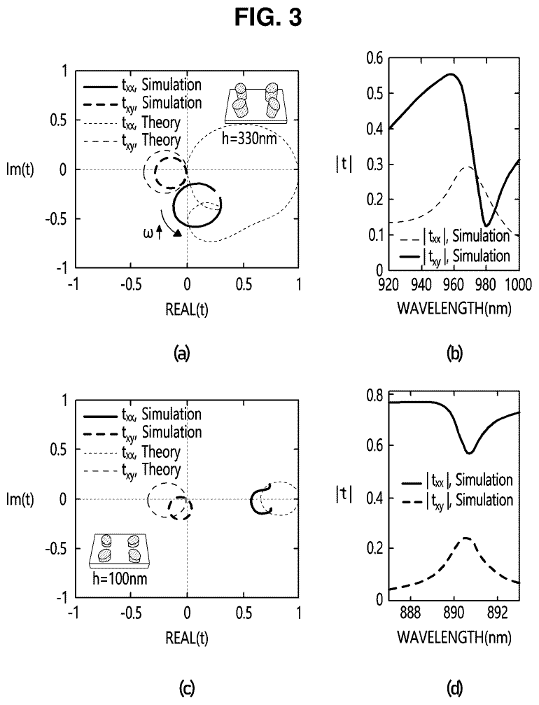

This will be described in more detail with reference to FIG. 2 and FIG. 3.

For example, referring to FIGS. 2(a) and 2(d), the unit structures in one structure group may be arranged in a combination of 0 degree and 90 degrees based on a long-axis direction. That is, a first unit structure may be arranged at 0 degree based on the long-axis direction, and a second unit structure may be arranged at 90 degrees which is an angle at which the first unit structure is rotated at 90 degrees in a clockwise direction or a counterclockwise direction. Similarly, a third unit structure may be arranged at an angle at which a long-axis direction of the second unit structure is rotated at 90 degrees again, and a fourth unit structure may be arranged at an angle at which a long-axis direction of the third unit structure is rotated at 90 degrees again.

As such, the unit structures in one structure group may be placed in a combination of 0 degrees and 90 degrees in the long axis direction to excite non-local dark mode resonance having electric dipoles of different directions due to symmetry breaking. Such resonance may interact with localized Mie resonance to generate Fano-shaped transmission spectra (FIG. 2(d)). Further, as illustrated in FIG. 2(a), a plurality of unit structures in one structure group are arranged in a rectangular lattice shape, so birefringence is induced and resonance is prevented in y-polarization, and high transmissions are enabled to be compared between two orthogonal polarizations.

As another example, referring to FIGS. 2(b) and 2(e), in order to detect y-axis polarization, four unit structures are arranged in a combination of 45 degrees and 135 degrees based on the long-axis direction in one structure group to selectively transmit y-axis linear polarization. In the case of both cases of FIGS. 2(a) and 2(b), a dark mode is selectively excited by each targeted polarization, but optical extension profiles in which an electric field is circulated around induced vertical magnetic dipoles are almost the same.

As yet another example, the arrangement will be described with reference to FIGS. 2(c) and 2(f).

According to yet another embodiment of the present disclosure, the arrangement of four unit structures in one structure group may enable chiral response. Four unit structures in one structure group may be placed in a combination of 22.5 degrees and 112.5 degrees based on the long-axis direction.

Through this, one structure group induces the opposite Fano resonance in x-axis and y-axis direction polarizations, and transmission of a high Q-factor is enabled with respect to opposite circular polarization through an interaction of the induced resonance.

As described above, metasurface layers 120a to 120d may be formed in which there is a remarkable difference between a targeted linear polarization or a targeted circular polarization while supporting the same non-local dark modes because of a similar geometric placement to a resonance mode profile through one structure group in which a plurality of unit structures having the same shape are arranged in a rectangular lattice arrangement as in an embodiment of the present disclosure.

In order to determine a resonance phase relationship for circular polarization selectivity, a transmission coefficient is analyzed and displayed in a complex plane as illustrated in FIG. 3(a). First, when phases and amplitudes of the same polarization component and cross polarization components transmitted in x-polarized light are examined, a small circle on a fourth quadrant specified by the Fano resonance is overlapped with a large circle induced by the Mie resonance which is coupled. Further, due to fine mirror symmetry breaking of the metasurface layers 120a to 120d according to an embodiment of the present disclosure (see FIG. 2(c)), x-axis direction cross-polarized light is induced during non-local Fano resonance of y-polarized light, which is represented by a dotted line in FIG. 3(a). The same phenomenon may also be generated even in an arrangement constituted by two unit cells.

In an interesting operating wavelength, phases of x-directed copolarization Tₓₓ and cross polarization T_{xy} satisfy a difference of approximately 90 degrees, and an interference is generated between cross and copolarized components of light due to additional 90-degree phase leading or lagging in a circular polarization state, and ultimately, strong and high Q circular dichroism may be caused.

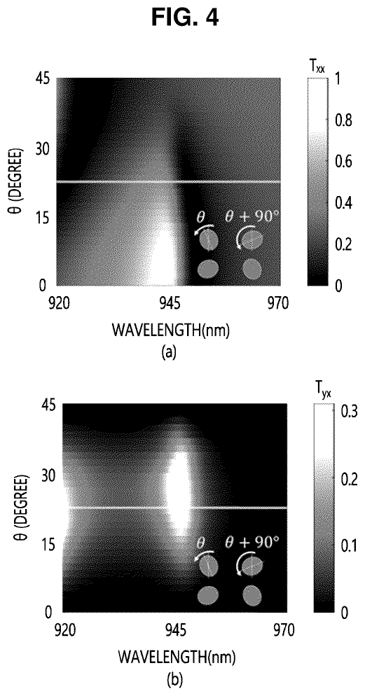

As illustrated in FIGS. 4 to 8, the orientation angle of the unit structure may be adjusted to generate of the appropriate cross polarized transmission components and optimize the phase relationship.

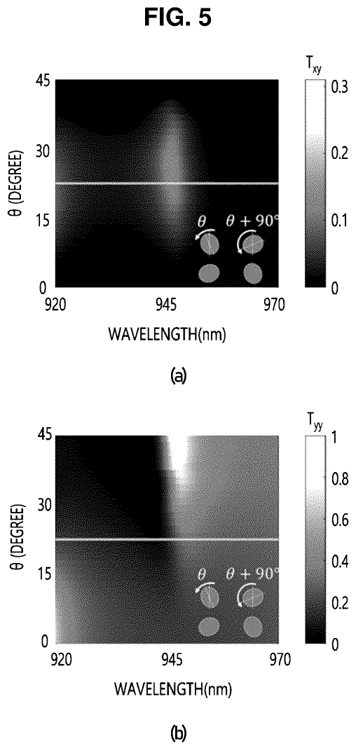

As illustrated in FIGS. 4(a) to 5(b), transmission spectrums of copolarization Tₓₓ and T_{yy} and cross polarization T_{yx} and T_{xy} are calculated under x and y-polarized incident light. It can be seen that when an orientation angle θ is close to 0 degree with respect to the x-polarized incident light (FIG. 4(a)), and y-polarized incident light is close to 45 degrees (FIG. 5(b)), enhanced transmission of copolarization having a Fano linear feature is observed. Further, it can be seen that cross polarization transmission becomes maximized at an angle of 22.5 degrees (FIGS. 4(b) and 5(a)), and even in such a case, a Fano spectrum is maintained in a copolarized transmission wave.

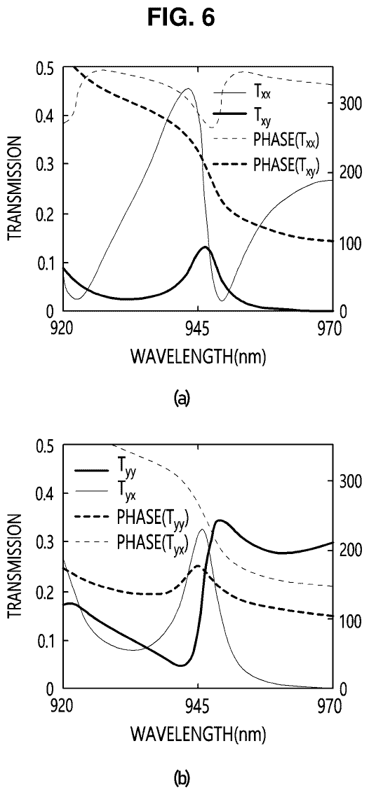

FIG. 6(a) is a diagram illustrating a fragment spectrum obtained along a white line displayed on a transmission panel at an optimized angle of 22.5 degrees. In FIG. 6(a), a phase difference less than 180 degrees from the shape of Fano resonance transmission (thick solid line) may be confirmed (thick dotted line). In contrast, the transmission of the cross polarized light is characterized by a Lorentzian shape, and a phase corresponding thereto changes from 0 degree to 180 degrees, and an optimal phase relationship of a difference of 90 degrees is formed between the copolarization and the cross polarization at an operating wavelength of 947 nm. It can be seen that the same optimal phase relationship is also satisfied for transmission under the y-polarized incident light (FIG. 6 (b)).

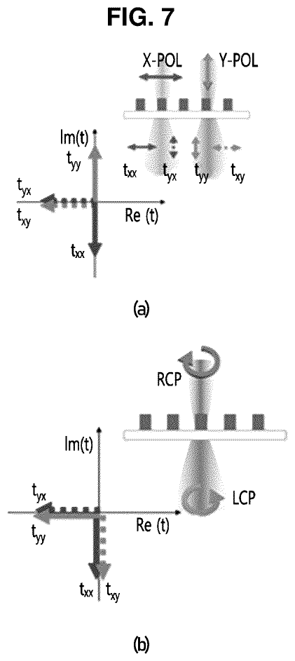

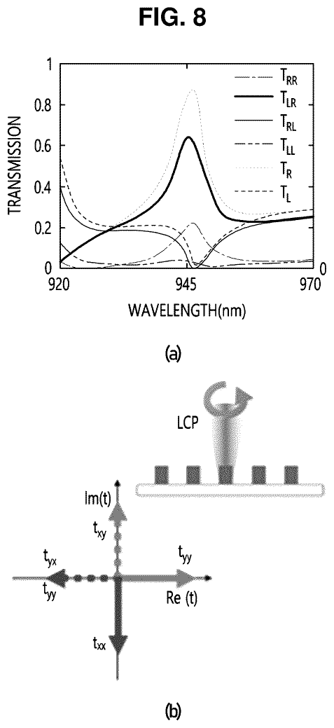

In order to additionally emphasize a role of a birefringence in the localized Mie resonance, vector diagram of respective transmission components are illustrated in FIGS. 7(a) and 8(b). Under X-directed polarized light, an X-directed copolarization (black solid line, Tₓₓ) and a y-directed cross polarization (black dotted line, T_{yx}) having a phase retardation of 90 degrees, and similarly, under Y-directed linearly polarized light, a y-directed copolarization (gray solid line, T_{yy}) and an x-directed cross polarization (gray dotted line, T_{xy}) are induced. As in an embodiment of the present disclosure, the unit structures in one structure group are arranged in a rectangular lattice, so the copolarized components Tₓₓ and T_{yy} may satisfy a phase difference of approximately 180 degrees due to a birefringence effect induced by the rectangular lattice (FIG. 7(a)). As illustrated in FIG. 7(b), in right-circularly polarized (RCP) incidence, additional 90-degree phase leading may occur, and constructive interference may be formed. In contrast, as illustrated in FIG. 8(b), in left-circularly polarized (LCP) incidence, 90-degree phase lagging may form destructive interference with respect to all components. Each polarization component of the transmitted light is illustrated in FIG. 8(a).

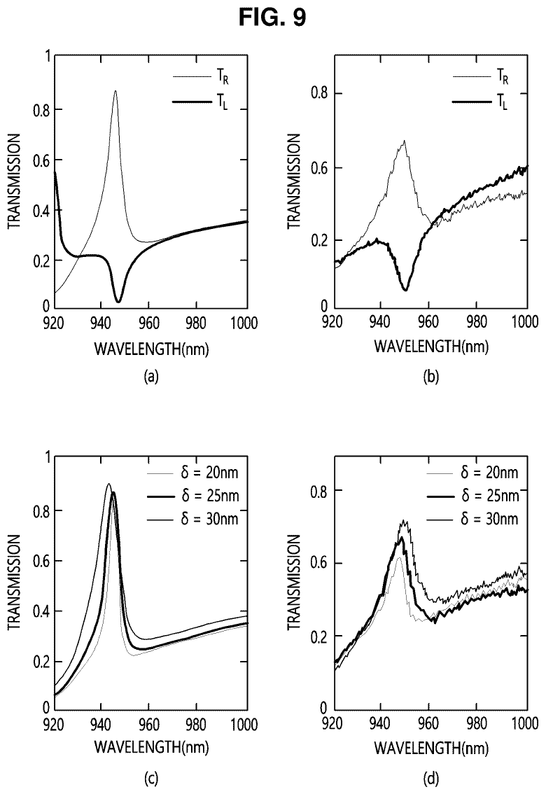

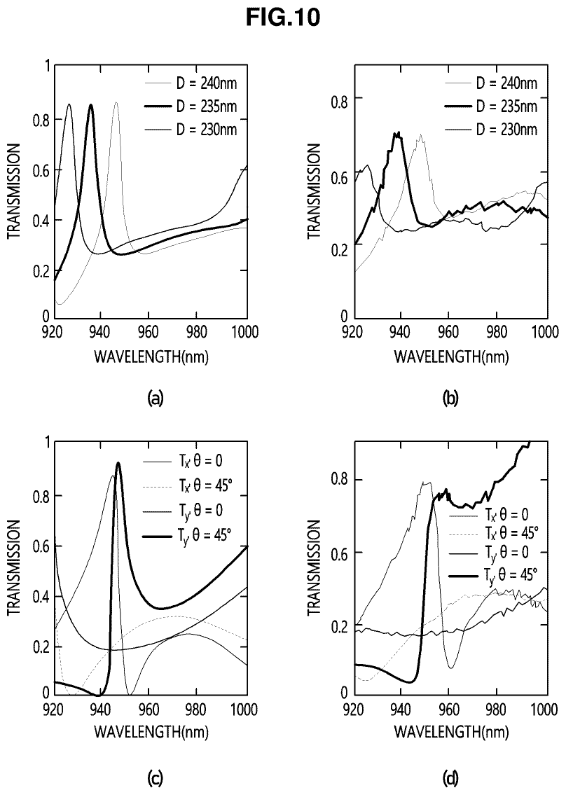

A result of measuring the transmission spectrum for verifying a design rule of the metasurface layer according to an embodiment of the present disclosure is illustrated in FIG. 9 and FIG. 10. A parameter is adjusted in order to control and detect targeted optical characteristics, and the metasurface layers 120a to 120d are manufactured.

First, transmittances of the metasurface layers 120a to 120d are measured under the circular polarization. As illustrated in FIGS. 9(a) and 9(b), it is illustrated that a transmittance for a targeted polarization is enhanced and suppressed in simulation and experiment spectrums, and it is confirmed that an experimentally determined Q-factor is 77.78.

An effect in which the elliptical axis ratio and size of the unit structure adjust the Q-factor and the operating wavelength of the non-local resonance, respectively, is investigated. As illustrated in FIGS. 9(c) and 9(d), it can be seen that when an axial difference δ is adjusted to 20, 25, and 30 nm, the Q-factor changes from 65 to 105 while maintaining the operating wavelength constantly. Thereafter, the operating wavelength is moved to a targeted spectrum region by changing the size of the ellipse while maintaining the parameters such as the orientation angle θ and the axial difference δ constantly (FIGS. 10(a) and 10(b)). Lastly, in order to adjust a response to a polarization, the orientation angle θ of the unit structure which is the component is changed to 0° and 90° or 45° and 135° to detect the x- or y-directed linear polarization, respectively. As illustrated in FIGS. 10(c) and 10(d), it may be observed that a Fano linear shape is transmitted in each targeted polarization. Fano linear shaped symmetric factors between two metasurfaces are caused due to a 180°-phase difference of the Mie resonance due to the birefringence effect.

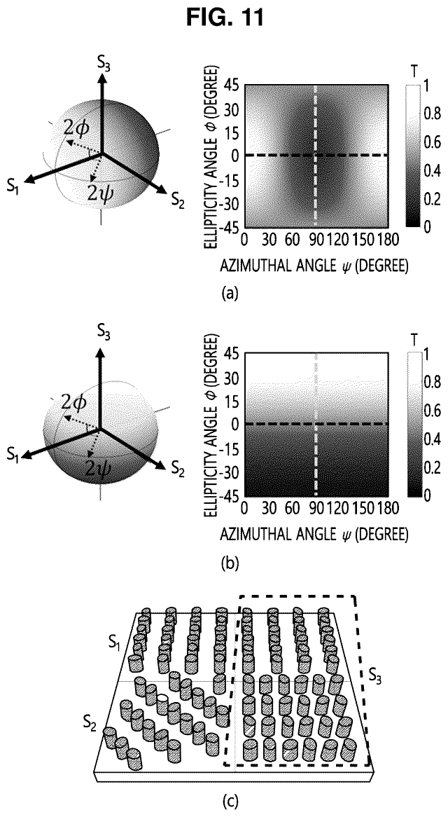

FIGS. 11 to 13 are diagrams illustrating a result of measuring various polarization states at a direction of an azimuthal angle and an ellipticity angle by using a metasurface combination according to an embodiment of the present disclosure.

As illustrated in FIGS. 11(a) and 11(b), each orthogonal corner of a Poincaré sphere may be effectively detected in a targeted narrowband spectrum by optimally adjusting the axial angle while fixing lattice sizes and the unit structures of the metasurface layers 120a to 120d.

For example, a unit structure in which the orientation angle θ is 0 degree may directly track an azimuthal angle path to maximize the x-polarization transmission and minimize the y-polarization transmission (FIG. 11(a)).

Further, a unit structure in which the orientation angle θ is 45 degrees may be used for tracking the azimuthal angle, but may maximize the y-polarization transmission. Similarly thereto, a unit structure in which the orientation angle θ is 22.5 degrees may track an ellipticity path to maximize the RCP transmission and minimize the LCP transmission (FIG. 11(b)). When both orthogonal unit structures are combined, transmission fluctuations may be removed along an azimuthal angle path near the equator. By integrating the azimuthal angle and an ellipticity angle acquired by such a scheme, detection of stroke parameters for all polarizations may be achieved from a total intensity of induced light without the pattern in the substrate.

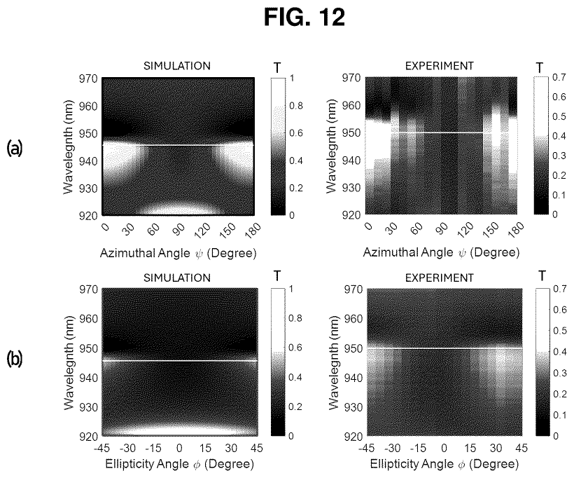

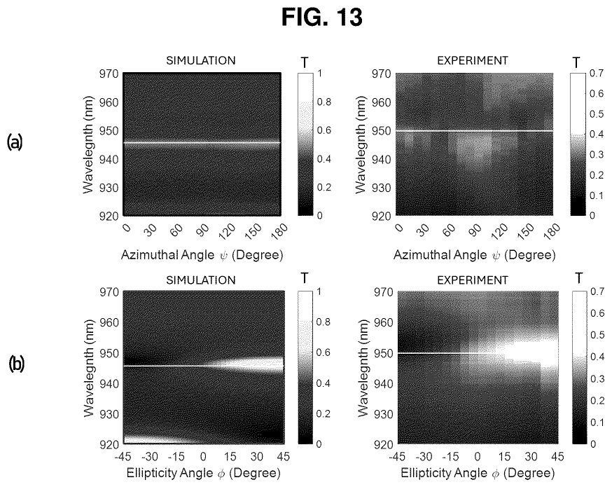

FIGS. 12(a) to 13(b) are diagrams illustrating a spectrum set for various angles along the azimuthal angle and the ellipticity path of the Poincaré sphere. FIGS. 12(a) and 12(b) illustrate an experimental result depending on an incident polarization change according to the azimuthal angle (FIG. 12(a)) and the ellipticity angle (FIG. 12(b)) of the unit structure in which the orientation angle θ is 0 degree. As illustrated in FIGS. 12(a) and 12(b), it can be seen that a Fano shape spectrum has a maximum transmission value at azimuthal angles of 0° and 180°.

FIGS. 13(a) and 13(b) are diagrams illustrating the spectrum of the unit structure in which the orientation angle θ is 22.5 degrees, and transmittance is shown to be highest at an ellipticity angle of 45 degrees, and this corresponds to the RCP, and gradually decreases by accessing the LCP. On the contrary, the transmission spectrum shows a constant value by minimum fluctuation in experimental measurement along the azimuthal angle path.

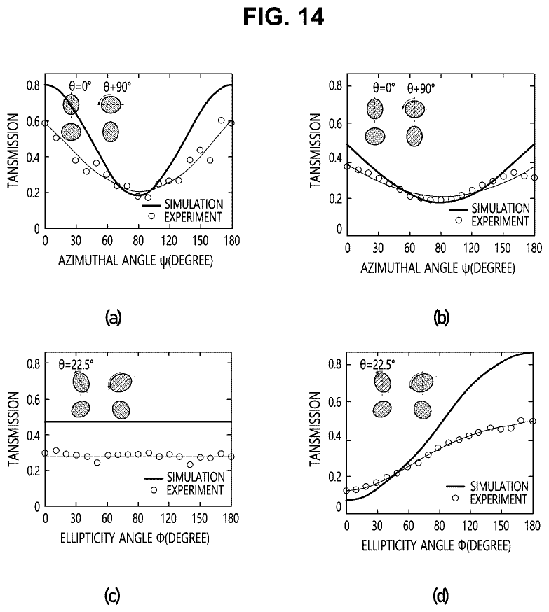

FIGS. 14(a) and 14(c) show cross-sectional normalized transmission spectrums along a horizontal dotted line in profiles of FIGS. 11(a) and 11(b), respectively, and show a consistent tendency according to an azimuthal angle change and a similarity between simulation analysis (black solid line) and experimental measurement (empty circle).

In addition, FIGS. 14(b) and 14(d) show the cross-sectional normalized transmission spectrum along a vertical dotted line, and show that a total transmittance of the unit structure for detecting the ellipticity angle increases monotonously as the ellipticity angle increases (FIG. 14(d)).

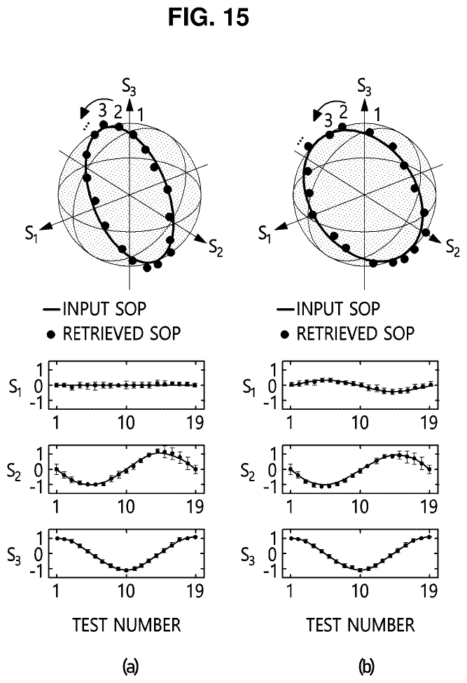

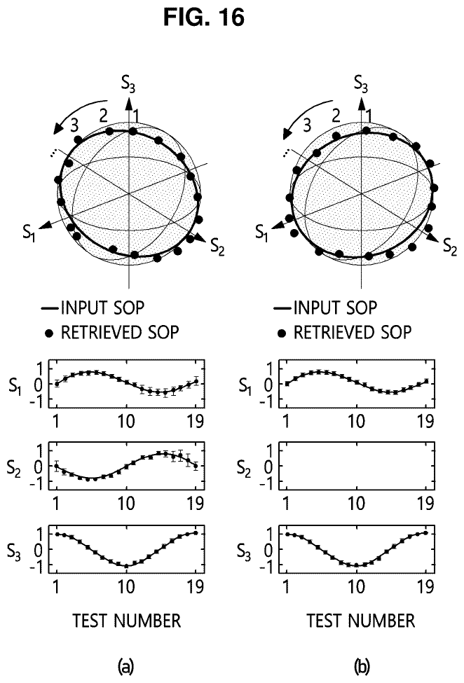

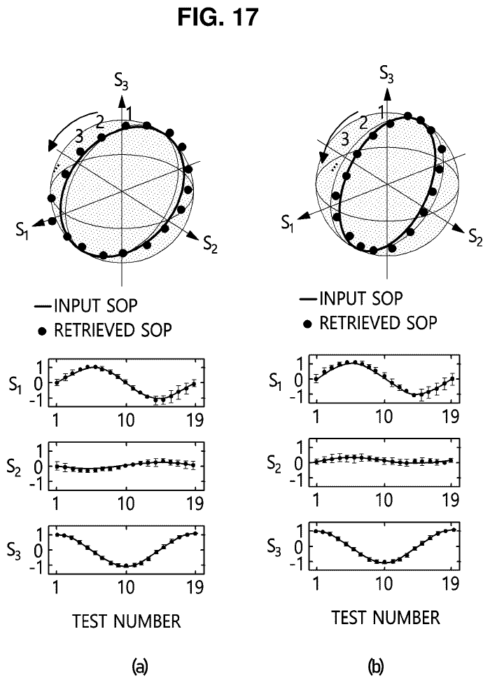

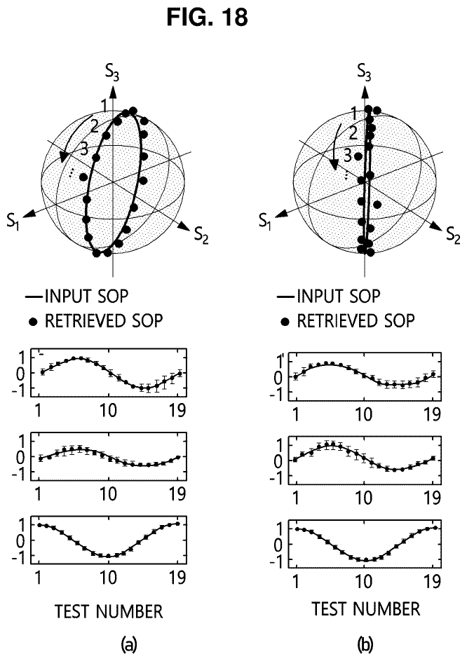

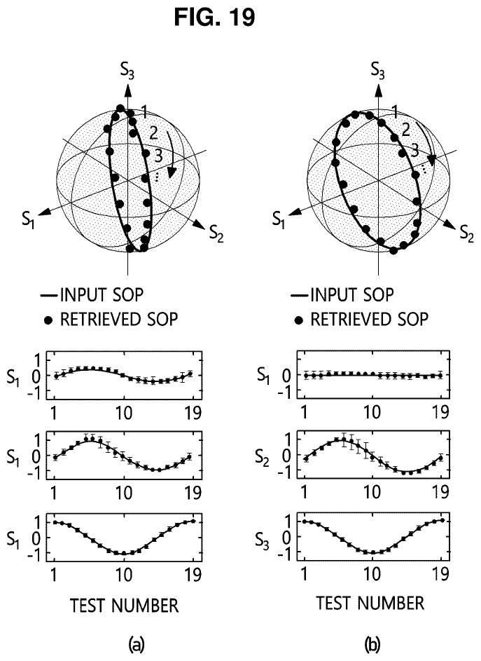

FIGS. 15 to 19 are diagrams illustrating a polarization state recovered from the metasurface layers 120a to 120d manufactured under various complex polarizations according to an embodiment of the present disclosure. A solid thine line of the Poincaré sphere indicates a polarization input, and a measurement result is marked by thick dotted lines. As a result of performing measurement by setting each of intervals of the azimuthal angle and the ellipticity angle to 10 degrees with respect to all points of the Poincaré sphere at a targeted wavelength of 950 nm, it can be seen that the measurement results match an actual polarization state (SOP) with slight differences of 0.047, 0.049, and 0.024 on average at the metasurfaces for S₁, S₂, and S₃, respectively.

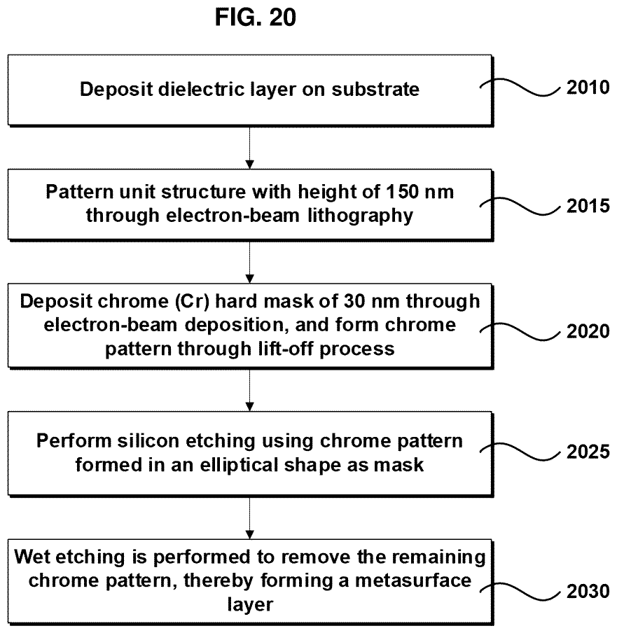

FIG. 20 is a flowchart illustrating a method of manufacturing a metasurface according to an embodiment of the present disclosure.

In step 1210, a dielectric layer is deposited on a substrate. The dielectric layer may be deposited on the substrate through low-pressure chemical vapor deposition (LPCVD). Here, the dielectric layer may be made of a polysilicon (poly-si) material. The dielectric layer may be deposited at a height of approximately 300 nm. This is just an example, and a deposition height of the dielectric layer may be changed, of course.

In step 2015, a unit structure with height of 150 nm is patterned through electron-beam lithography.

Next, in step 2020, a chrome (Cr) hard mask of 30 nm is deposited through electron-beam deposition, and a chrome pattern is formed through a lift-off process.

In step 2025, a chrome pattern formed in an elliptical shape is used as a mask to perform silicon etching.

Lastly, in step 2030, wet etching is performed in order to eliminate a chrome pattern which remains. Through this, the metasurface layers 120a to 120d may be formed.

The apparatus and the method according to the embodiment of the present disclosure may be implemented in a form of a program command which may be performed through various computer means and recorded in the computer readable medium. The computer readable medium may include a program command, a data file, a data structure, and the like alone or in combination thereof. The program commands recorded in the computer readable medium may be those specially designed and configured for the present disclosure, or may be those publicly known to and used by those skilled in the computer software field. Examples of the computer-readable recording medium include magnetic media such as a hard disk, a floppy disk, and a magnetic tape, optical media such as a CD-ROM and a DVD, magneto-optical media such as a floptical disk, and a hardware device which is specifically configured to store and execute the program commands such as a ROM, a RAM, and a flash memory. Examples of the program command include a high-level language code executable by a computer using an interpreter and the like, as well as a machine language code created by a compiler.

The hardware device described above may be configured to be operated with one or more software modules in order to perform the operation of the present disclosure, and vice versa.

The present disclosure has been described so far on the basis of the embodiments thereof. It is understood to those skilled in the art that the present disclosure may be implemented as a modified form without departing from an essential characteristic of the present disclosure. Therefore, the disclosed embodiments should be considered in an illustrative viewpoint rather than a restrictive viewpoint. The scope of the present disclosure is defined by the appended claims rather than by the foregoing description, and all differences within the scope of equivalents thereof should be construed as being included in the present disclosure.

What is claimed is:

1. A metasurface filter, comprising:
a substrate; and
a metasurface layer in which a plurality of unit structures formed on the substrate and having the same shape are arranged to form one structure group, and at least one of a specific polarization and a specific wavelength is blocked according to resonance according to an arrangement of the unit structures in one structure group,
wherein the plurality of unit structures forming the one structure group are placed to have different angles.

2. The metasurface filter of claim 1, wherein the unit structure is formed to have a predetermined height in an elliptical shape with a length ratio of a long axis and a short axis of 1.05 to 1.2:1.

3. The metasurface filter of claim 1, wherein in the one structure group, four unit structures are arranged, and arranged to have an angle difference of 90 degrees from an adjacent unit structure.

4. The metasurface filter of claim 1, wherein in the one structure group, the plurality of unit structures are arranged in a rectangular lattice shape.

5. The metasurface filter of claim 1, wherein the metasurface layer is formed by a combination of a plurality of structure groups, and
orientation angles of the unit structures in the plurality of structure groups are different from each other.

6. The metasurface filter of claim 5, wherein the plurality of structure groups are formed by at least one among
a first group arranged in a rectangular lattice so that a long-axis based orientation angle of the unit structure has 0 degree and 90 degrees,
a second group arranged in the rectangular lattice so that the long-axis based orientation angle of the unit structure has 45 degree and 135 degrees,
a third group arranged in the rectangular lattice so that the long-axis based orientation angle of the unit structure has 22.5 degree and 112.5 degrees, and
a fourth group arranged in the rectangular lattice so that the long-axis based orientation angle of the unit structure has −22.5 degree and 67.5 degrees, or
by a combination of the first to third groups.

7. The metasurface filter of claim 1, wherein the unit structure is made of a dielectric material.

8. A method of manufacturing a metasurface, comprising:
depositing a dielectric layer on a substrate;
patterning a unit structure shape on the dielectric layer through electron-beam lithography;
depositing a chrome hard mask through electron-beam deposition, and then performing a lift-off process to form a chrome pattern; and
performing silicon etching by using the chrome pattern as a mask, and then eliminating the chrome pattern through wet etching,
wherein an orientation angle of the unit structure is determined differently according to at least one of a targeted polarization and a targeted wavelength.
